(19) United States
(12) Patent Application Publication
(10) Pub. No.: US 2022/0027539 A1
(43) Pub. Date: Jan. 27, 2022

(54) METHOD AND SYSTEM FOR MANUFACTURING A HEAT EXCHANGER FOR SUPERCRITICAL PRESSURE FLUID

(71) Applicant: Tsinghua University, Beijing (CN)

(72) Inventors: Ruina XU, Beijing (CN); Peixue JIANG, Beijing (CN); Chao WANG, Beijing (CN); Zhipeng ZHANG, Beijing (CN)

(21) Appl. No.: 17/368,104

(22) Filed: Jul. 6, 2021

(30) Foreign Application Priority Data
Jul. 23, 2020 (CN) 202010716041.6

(51) Int. Cl. G06F 30/28; G06F 17/18

(52) U.S. Cl. CPC G06F 30/28; G06F 2119/08; G06F 17/18

(57) ABSTRACT

A method and a system for manufacturing a heat exchanger for supercritical pressure fluid are provided. The manufacturing method includes: obtaining boundary conditions of the heat exchanger, adjusting a preliminary framework of the heat exchanger, dividing each of fluid passages along a fluid flow direction and establishing a thermal equilibrium control model, constructing a machine heat transfer model in combination with a Gaussian regression process and a Cokriging method based on the thermal equilibrium control model, determining on-way thermal parameters about the working fluids flowing and transferring heat, determining a heat transfer area according to the on-way thermal parameters, and determining whether the heat transfer area meets a target heat transfer area. If the heat transfer area meets the target heat transfer area the heat exchanger is manufactured according to the preliminary framework of the heat exchanger. If the heat transfer area does not meet the target transfer area, the primary framework of the heat exchanger is readjusted until the heat transfer area meets the target heat transfer area.

### CROSS REFERENCE TO RELATED APPLICATION

This application claims the priority of Chinese Patent Application No. 202010716041.6, entitled “METHOD AND SYSTEM FOR MANUFACTURING A HEAT EXCHANGER FOR SUPERCRITICAL PRESSURE FLUID” filed with the China National Intellectual Property Administration on Jul. 23, 2020, which is incorporated herein by reference in its entirety.

### TECHNICAL FIELD

The disclosure relates to the field of manufacture of a heat exchanger for supercritical pressure fluid, and in particular, to a method and a system for manufacturing a heat exchanger for supercritical pressure fluid.

### BACKGROUND ART

The supercritical CO₂ Brayton cycle is a Brayton cycle with CO₂ at a supercritical pressure as a working fluid. Compared with traditional cycles, it has the advantages of low power consumption in compression, high overall efficiency and compact structure. The CO₂ at supercritical pressure as a main working fluid has the characteristics of high density, low viscosity, strong diffusivity and permeability and the like, so the supercritical CO₂ Brayton cycle has wide development prospects in the fields of aero engines, fourth generation nuclear reactors, solar thermal power and the like. Since CO₂ at an inlet of a compressor during the cycle is close to a critical state, the convection heat transfer rule is very complex due to significantly variable physical properties of the CO₂, and thereby, it is necessary to study the internal flow and heat transfer rule of the heat exchanger.

A type of heat exchanger possibly used for the supercritical CO₂ brayton cycle is a printed circuit heat exchanger (PCHE). The PCHE is manufactured by engraving grooves on metal substrates as cold and hot fluid flow passages, and then stacking cold and hot substrates alternately and welding these substrates through a diffusion bonding technology. Compared with the traditional heat exchangers, the PCHE has the advantages of better strength and integrity, and withstanding harsh conditions such as high temperature, high pressure, and large temperature difference.

At present, a more common design calculation method of PCHE is an overall design method based on inlet and outlet parameters of a heat exchanger with a logarithmic mean temperature difference method. Such method mainly includes: after determining a flow form of the heat exchanger, determining a fourth temperature value according to thermal equilibrium based on given heat transfer quantity and three temperatures of inlet and outlet temperatures at a cold side and a hot side of the heat exchanger, and calculating the logarithmic mean temperature difference. Assuming that the average values of the inlet and outlet temperatures are respectively temperature values of a fluid at the cold side and the hot side, an average Nusselt number and a heat transfer coefficient are calculated by using a correlation equation, and thereby structural parameters such as a heat transfer area, a passage length of the heat exchanger are determined after determining average physical parameters. The result designed by adopting the overall design method based on the average values of the inlet and outlet parameters is often rough, and is difficult to reflect the local convective heat transfer performance in the flow passages.

In order to solve the problem, areas of flow passages of the heat exchanger to be calculated can be discretized, and processes of calculation and iteration similar to the average method can be carried out on the areas discretized to obtain local convective heat transfer coefficients along the passages. However, on the one hand, a result obtained by using the correlation equation without considering changes in physical properties often has a low precision due to the variable physical properties of the supercritical pressure fluid. On the other hand, as the size of the passages in the heat exchanger is reduced, the influence of a heat acceleration phenomenon on the heat transfer is significantly increased, and in this case a prediction precision of the existing correlation is reduced, so that the precision and the reliability of the calculated result is greatly influenced. In addition, for complex working conditions, it often requires 100 or more data points to construct the correlation equation, and it is difficult to obtain a large number of high-precision data points, and the cost is also very high.

### SUMMARY

The embodiments aim to provide a method and a system for manufacturing a heat exchanger for supercritical pressure fluid to solve the difficulties of obtaining a large number of high-precision data points to construct a correlation equation in the existing manufacturing process of a heat exchanger for supercritical pressure fluid, which causes some problems, such as, the precision of structural parameters of predicted heat exchanger is low, and thus the manufactured heat exchanger is poor in performance.

In order to achieve the above object, the disclosure provides the following solutions.

It is provided a method for manufacturing a heat exchanger for supercritical pressure fluid, which has a first working fluid arranged in hot fluid passages of the heat exchanger and a second working fluid arranged in cold fluid passages of the heat exchanger. The method includes:
obtaining boundary conditions of the heat exchanger; the boundary conditions including first working fluid parameters and second working fluid parameters, the first working fluid parameters including an inlet temperature, an outlet temperature, a pressure and a flow of the first working fluid, the second working fluid parameters including an inlet temperature, an outlet temperature, a pressure and a flow of the second working fluid;
adjusting a preliminary framework of the heat exchanger based on the boundary conditions, the preliminary framework of the heat exchanger including a passage equivalent diameter, a passage length, a passage number, and arrangements of cold fluid passages and hot fluid passages of the heat exchanger;
dividing each of fluid passages along a fluid flow direction and establishing a thermal equilibrium control model for each divided fluid passage based on the preliminary framework of the heat exchanger, the fluid passages including hot fluid passages and cold fluid passages, each of the fluid passages including a plurality of the divided fluid passages;
constructing a machine heat transfer model in combination with a Gaussian regression process and a Cokriging method based on the thermal equilibrium control model;
determining on-way thermal parameters about the working fluids flowing and transferring heat in the fluid passages according to the machine heat transfer model, the on-way thermal parameters including a fluid temperature, a fluid velocity and a pressure loss;
determining a heat transfer area according to the on-way thermal parameters;
determining whether the heat transfer area meets a target heat transfer area to obtain a first determination result:
manufacturing the heat exchanger according to the preliminary framework of the heat exchanger, if the determination of on-way thermal parameters result indicates that the heat transfer area meets the target heat transfer area; and
readjusting the primary framework of the heat exchanger until the heat transfer area meets the target heat transfer area, if the determination of on-way thermal parameters result indicates that the heat transfer area fails to meet the target heat transfer area.

In some embodiments, the adjusting a preliminary framework of the heat exchanger based on the boundary conditions specifically includes:
determining an average Nusselt number according to the first working fluid parameters and the second working fluid parameters;
determining a first average convective heat transfer coefficient of the first working fluid and a second average convective heat transfer coefficient of the second working fluid, respectively, and determining the passage equivalent diameter according to the average Nusselt number;
determining a total heat transfer coefficient according to the first average convective heat transfer coefficient and the second average convective heat transfer coefficient;
determining a heat transfer quantity according to the total heat transfer coefficient;
determining the passage length and the passage number according to the heat transfer quantity;
determining the arrangements of cold fluid passages and hot fluid passages according to the passage length and the passage number;
determining the preliminary framework of the heat exchanger according to passage equivalent diameter, passage length, passage number, and the arrangements of cold fluid passages and hot fluid passages.

In some embodiments, the dividing each of fluid passages along a fluid flow direction and establishing a thermal equilibrium control model for each divided fluid passage based on the preliminary framework of the heat exchanger specifically includes:

the thermal equilibrium control model being as follows:

qᵢ=q_{m_hi}c_{p_hi}(tₕᵢ−tₕᵢ₊₁)

qᵢ=q_{m_ci}c_{p_ci}(t_{ci}−t_{ci+1})

qᵢ=kᵢAᵢ(t_{m_hi}−t_{m_ci});

where qᵢ is a heat flux in a i-th divided fluid passage; q_{m_ci} is a flow of a cold fluid; q_{m_hi} is a flow of a hot fluid; c_{p_hi} is a specific heat capacity at constant pressure of the hot fluid; c_{p_ci} is a specific heat capacity at constant pressure of the cold fluid; t_{m_ci} is a temperature of the first working fluid at a central node of the i-th divided fluid passage; t_{m_hi} is a temperature of the second working fluid at the central node of the i-th divided fluid passage; Aᵢ is a heat transfer area in the i-th divided fluid passage; i represents the i-th divided fluid passage; and i+1 represents a next divided fluid passage relative to the i-th divided fluid passage.

In some embodiments, the constructing a machine heat transfer model in combination with a Gaussian regression process and a Cokriging method based on the thermal equilibrium control model specifically includes:
obtaining heat transfer data of the supercritical pressure fluid, the heat transfer data of the supercritical pressure fluid including high-precision and low-precision heat transfer data, the high-precision heat transfer data being a data set obtained from experiment or numerical simulation data, the low-precision heat transfer data being a data set predicted by dimensionless criterion correlation equation, the heat transfer data of the supercritical pressure fluid being an on-way flow rate of the fluid, a wall surface temperature, a temperature of a main flow of the fluid, a fluid pressure, a convective heat transfer coefficient and a passage characteristic length;
preprocessing the heat transfer data of the supercritical pressure fluid, and determining preprocessed heat transfer data of the supercritical pressure fluid, the preprocessed heat transfer data of the supercritical pressure fluid including preprocessed low-precision and preprocessed high-precision heat transfer data;
determining a low-precision model according to the preprocessed low-precision heat transfer data based on a Gaussian regression equation;
determining a high-precision model according to the preprocessed high-precision heat transfer data based on the Gaussian regression equation;
determining a multi-precision model according to the low-precision heat transfer data, the low-precision model, the high-precision heat transfer data and the high-precision model by utilizing a Cokriging method based on the thermal equilibrium control model, the multi-precision model being a machine heat transfer model which takes dimensionless parameters of screened heat transfer data of the supercritical pressure fluid as an input and takes the convective heat transfer coefficient as an output, the screened heat transfer data of the supercritical pressure fluid including an on-way flow rate of the fluid, the wall surface temperature, main flow temperature of the fluid, fluid pressure, convective heat transfer coefficient and the passage characteristic length, the machine heat transfer model being used for determining on-way thermal parameters about the working fluids flowing and transferring heat in the fluid passages.

In some embodiments, the determining a multi-precision model according to the low-precision heat transfer data, the low-precision model, the high-precision heat transfer data and the high-precision model by utilizing a Cokriging method specifically includes:
dividing the high-precision heat transfer data into a training set and a testing set;
determining a multi-precision model according to a formula: \hat{f}₂(X)=ρ(X)\hat{f}₁(X)+δ(X) by utilizing the training set, where \hat{f}₂(X) is a high-precision model; \hat{f}₁(X) is a low-precision model; ρ(X) is a scale factor for quantifying a relationship between outputs of two precision models; δ(X) is a Gaussian process.

A system for manufacturing a heat exchanger for supercritical pressure fluid, which has a first working fluid arranged in hot fluid passages of the heat exchanger and a second working fluid arranged in cold fluid passages of the heat exchanger, the system includes:

a module for obtaining boundary conditions, configured for obtaining the boundary conditions of the heat exchanger, the boundary conditions including first and second working fluid parameters, the first working fluid parameters including an inlet temperature, an outlet temperature, a pressure and a flow of the first working fluid; the second working fluid parameters including an inlet temperature, an outlet temperature, a pressure and a flow of the second working fluid;

a module for adjusting a preliminary framework of the heat exchanger, configured for adjusting the preliminary framework of the heat exchanger based on the boundary conditions, the preliminary framework of the heat exchanger including a passage equivalent diameter, a passage length, a passage number, and arrangements of cold fluid passages and hot fluid passages of the heat exchanger;

a module for establishing a thermal equilibrium control model, configured for dividing each of fluid passages along a fluid flow direction and establishing the thermal equilibrium control model for each divided fluid passage based on the preliminary framework of the heat exchanger, the fluid passages including hot fluid passages and cold fluid passages, each of the fluid passages including a plurality of the divided fluid passages;

a module for constructing a machine heat transfer model, configured for constructing the machine heat transfer model in combination with a Gaussian regression process and a Cokriging method based on the thermal equilibrium control model;

a module for determining on-way thermal parameters, configured for determining on-way thermal parameters about the working fluids flowing and transferring heat in the fluid passages according to the machine heat transfer model, the on-way thermal parameters including a fluid temperature, a fluid velocity and a pressure loss;

a module for determining a heat transfer area, configured for determining the heat transfer area according to the on-way thermal parameters;

a first determination module, configured for determining whether the heat transfer area meets a target heat transfer area, to obtain a first determination result;

a module for manufacturing the heat exchanger, configured for manufacturing the heat exchanger according to the preliminary framework of the heat exchanger, if the first determination result indicates that the heat transfer area meets the target heat transfer area; and a module for adjusting the preliminary framework of the heat exchanger, configured for readjusting the primary framework of the heat exchanger until the heat transfer area meets the target heat transfer area, if the first determination result indicates that the heat transfer area fails to meet the target heat transfer area.

In some embodiments, the module for adjusting the preliminary framework of the heat exchanger specifically includes:

an unit for determining an average Nusselt number, configured for determining an average Nusselt number according to the first and the second working fluid parameters;

an unit for determining a passage equivalent diameter, configured for determining a first average convective heat transfer coefficient of the first working fluid and a second average convective heat transfer coefficient of the second working fluid respectively and determining the passage equivalent diameter according to the average Nusselt number;

an unit for determining a total heat transfer coefficient, configured for determining the total heat transfer coefficient according to the first average convective heat transfer coefficient and the second average convective heat transfer coefficient;

an unit for determining a heat transfer quantity, configured for determining the heat transfer quantity according to the total heat transfer coefficient;

an unit for determining the passage length and the passage number, used for determining the passage length and the passage number according to the heat transfer quantity;

an unit for determining the arrangements of cold fluid passages and hot fluid passages, configured for determining the arrangements of cold fluid passages and hot fluid passages according to the passage length and the passage number;

an unit for determining a preliminary framework of the heat exchanger, configured for determining a preliminary framework of the heat exchanger according to the passage equivalent diameter, the passage length, the passage number, and the arrangements of cold fluid passages and hot fluid passages.

In some embodiments, the module for establishing the thermal equilibrium control model specifically includes:

an unit for establishing a thermal equilibrium control model, configured for establishing a thermal equilibrium control model, and the thermal equilibrium control model being as follows:

qᵢ=q_{m_hi}c_{p_hi}(tₕᵢ−tₕᵢ₊₁)

qᵢ=q_{m_ci}c_{p_ci}(t_{ci}−t_{ci+1})

qᵢ=kᵢAᵢ(t_{m_hi}−t_{m_ci});

where qᵢ is a heat flux in the i-th divided fluid passage; q_{m_ci} is a flow of a cold fluid; q_{m_hi} is a flow of a hot fluid; c_{p_hi} is a specific heat capacity at constant pressure of the hot fluid; c_{p_ci} is a specific heat capacity at constant pressure of the cold fluid; t_{m_ci} is a temperature of the first working fluid at a central node of the i-th divided fluid passage; t_{m_hi} is a temperature of the second working fluid at the central node of the i-th divided fluid passage; Aᵢ is a heat transfer area in the i-th divided fluid passage; i represents the i-th divided fluid passage; and i+1 represents a next divided fluid passage relative to the i-th divided fluid passage.

In some embodiments, the module for constructing the machine heat transfer model specifically includes:

a module for obtaining heat transfer data of the supercritical pressure fluid, configured for obtaining the heat transfer data of the supercritical pressure fluid, the heat transfer data of the supercritical pressure fluid including high-precision and low-precision heat transfer data, the high-precision heat transfer data being a data set obtained from experimental or numerical simulation data; the low-precision heat transfer data being a data set predicted by dimensionless criterion correlation equation, the heat transfer data of the supercritical pressure fluid being an on-way flow rate of the fluid, a wall surface temperature, a temperature of a main flow of the fluid, a fluid pressure, a convective heat transfer coefficient and a passage characteristic length;

a preprocessing module, configured for preprocessing the heat transfer data of the supercritical pressure fluid, and determining preprocessed heat transfer data of the supercritical pressure fluid, the preprocessed heat transfer data of the supercritical pressure fluid including preprocessed low-precision and preprocessed high-precision heat transfer data;

a module for determining a low-precision model, configured for determining the low-precision model according to the preprocessed low-precision heat transfer data based on a Gaussian regression equation;

a module for determining a high-precision model, configured for determining the high-precision model according to the preprocessed high-precision heat transfer data based on the Gaussian regression equation;

a module for determining a multi-precision model, configured for determining a multi-precision model according to the low-precision heat transfer data, the low-precision model, the high-precision heat transfer data and the high-precision model by utilizing a Cokriging method based on the thermal equilibrium control model, the multi-precision model being a machine heat transfer model which takes dimensionless parameters of screened heat transfer data of the supercritical pressure fluid as an input and takes the convective heat transfer coefficient as output, the screened heat transfer data of the supercritical pressure fluid including the on-way flow rate of the fluid, the wall surface temperature, the temperature of the main flow of the fluid, the fluid pressure, the convective heat transfer coefficient and the passage characteristic length, the machine heat transfer model being used for determining on-way thermal parameters about the working fluids flowing and transferring heat in the fluid passages.

In some embodiments, the module for determining the multi-precision model specifically includes:

a dividing unit, configured for dividing the high-precision heat transfer data into a training set and a testing set;

an unit for determining the multi-precision model, configured for determining the multi-precision model according to a formula: \hat{f}₂(X)=ρ(X)\hat{f}₁(X)+δ(X) by utilizing the training set, where \hat{f}₂(X) is a high-precision model; \hat{f}₁(X) is a low-precision model; ρ(X) is a scale factor for quantifying a relationship between output values of two precision models; δ(X) is a Gaussian process.

According to the specific embodiments provided by the disclosure, the disclosure has the following technical effects. The disclosure provides a method and a system for manufacturing a heat exchanger for supercritical pressure fluid, which determine a preliminary framework of the heat exchanger according to given boundary conditions of the heat exchanger, and construct a machine heat transfer model in combination with a Gaussian regression process and a Cokriging method, and continuously adjust the preliminary framework of the heat exchanger in an iterative manner by utilizing the machine heat transfer model instead of the existing correlation equation, enabling the finally determined heat transfer area meet a target heat transfer area, and then manufacture the heat exchanger by utilizing the adjusted preliminary framework of the heat exchanger, without a large number of high-precision data points, so as to improve the heat transfer performance of the heat exchanger.

### BRIEF DESCRIPTION OF THE DRAWINGS

In order to more clearly illustrate the embodiments of the disclosure or the technical solutions in the conventional art, the drawings used in the embodiments will be briefly described below, it is apparent that the drawings in the following description are only some embodiments of the disclosure, for those skilled in the art, other drawings can be obtained according to the drawings without inventive labors.

FIG. 1 is a flowchart of a method for manufacturing a heat exchanger for supercritical pressure fluid according to the present disclosure;

FIG. 2 is a flowchart of a design method of the heat exchanger for supercritical pressure fluid in combination with machine learning provided by the present disclosure; and

FIG. 3 is a structural chart of a system for manufacturing the heat exchanger for supercritical pressure fluid provided by the present disclosure.

### DETAILED DESCRIPTION OF THE EMBODIMENTS

The technical solutions in the embodiments of the present disclosure will be clearly and completely described below combining with the accompanying drawings in the embodiments of the present disclosure, and it is apparent that embodiments described are only a part of embodiments of the present disclosure, and not all of them. All other embodiments, which are obtained by a person skilled in the art based on the embodiments of the present disclosure without inventive labors, shall fall within the protection scope of the present disclosure.

The disclosure aims to provide a method and a system for manufacturing a heat exchanger for supercritical pressure fluid, which can improve a performance of the heat exchanger for supercritical pressure fluid.

In order to make the above purposes, features and advantages of the present disclosure more comprehensible, the present disclosure is further and detailedly described combining with the accompanying drawings and specific embodiments thereof.

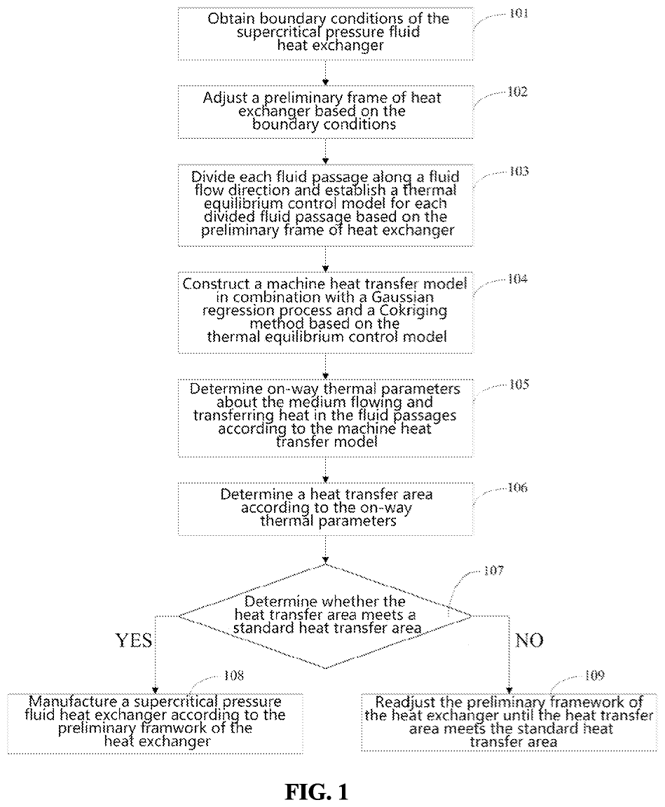

FIG. 1 is a flowchart of the method for manufacturing the heat exchanger for supercritical pressure fluid according to the present disclosure. It is provided the method for manufacturing the heat exchanger for supercritical pressure fluid as shown in FIG. 1, in which first working fluid is arranged in hot fluid passages of the heat exchanger for supercritical pressure fluid, and a second working fluid is arranged in cold fluid passages of the heat exchanger for supercritical pressure fluid, the method includes:

In step 101, boundary conditions of the heat exchanger for supercritical pressure fluid are obtained. The boundary conditions include first and second working fluids' parameters. The first working fluid parameters include an inlet temperature, an outlet temperature, a pressure and a flow of the first working fluid, and the second working fluid parameters include an inlet temperature, an outlet temperature, a pressure and a flow of the second working fluid.

In step 102, a preliminary framework of the heat exchanger is adjusted based on the obtained boundary conditions. The preliminary framework of the heat exchanger includes a passage equivalent diameter, a passage length and a passage number, and arrangements of the cold fluid passages and the hot fluid passages of the heat exchanger.

The step 102 includes:
determining an average Nusselt number according to the first and the second working fluid parameters;
determining a first average convective heat transfer coefficient of the first working fluid and a second average convective heat transfer coefficient of the second working fluid respectively and determining the passage equivalent diameter according to the average Nusselt number;
determining a total heat transfer coefficient according to the first average convective heat transfer coefficient and the second average convective heat transfer coefficient;
determining a quantity of transferred heat according to the total heat transfer coefficient;
determining the passage length and the passage number according to the quantity of transferred heat;
determining the arrangements of cold fluid passages and hot fluid passages according to the passage length and the passage number; and
determining the preliminary framework of the heat exchanger according to the passage equivalent diameter, the passage length, the passage number, and the arrangements of cold fluid passages and hot fluid passages.

In step 103, each of the fluid passages is divided along a fluid flow direction and a thermal equilibrium control model is established for each divided fluid passage based on the preliminary framework of heat exchanger. The fluid passages include hot fluid passages and cold fluid passages, each of the fluid passages includes multiple divided fluid passages.

The step 103 includes the following operations. The thermal equilibrium control model is as follows:

qᵢ=q_{m_hi}c_{p_hi}(tₕᵢ−tₕᵢ₊₁)

qᵢ=q_{m_ci}c_{p_ci}(t_{ci}−t_{ci+1})

qᵢ=kᵢAᵢ(t_{m_hi}−t_{m_ci});

where qᵢ is a heat flux through the i-th divided fluid passage; q_{m_ci} is a flow of the cold fluid (here, is the second working fluid); q_{m_hi} is a flow of the hot fluid (here, is the first working fluid); c_{p_hi} is a specific heat capacity at constant pressure for the hot fluid; c_{p_ci} is a specific heat capacity at constant pressure for the cold fluid; t_{m_ci} is a temperature of the first working fluid at a central node of the i-th divided fluid passage; t_{m_hi} is a temperature of the second working fluid at the central node of the i-th divided fluid passage; Aᵢ is a heat transfer area in the i-th divided fluid passage; i represents the i-th divided fluid passage, and i+1 represents a next divided fluid passage relative to the i-th divided fluid passage.

In step 104, a machine heat transfer model is constructed in combination with a Gaussian regression process and a Cokriging method based on the thermal equilibrium control model.

The step 104 includes:
obtaining heat transfer data of the supercritical pressure fluid, the heat transfer data of the supercritical pressure fluid include high-precision and low-precision heat transfer data, the high-precision heat transfer data are a data set obtained by data from experiment or numerical simulation; the low-precision heat transfer data are a data set predicted by dimensionless criterion correlation equation, the heat transfer data of the supercritical pressure fluid are an on-way flow rate of the fluid, a wall surface temperature, a main flow temperature of the fluid, a fluid pressure, a convective heat transfer coefficient and a passage characteristic length;
preprocessing the heat transfer data of the supercritical pressure fluid, and determining preprocessed heat transfer data of the supercritical pressure fluid, the preprocessed heat transfer data of the supercritical pressure fluid include preprocessed low-precision and preprocessed high-precision heat transfer data;
determining a low-precision model according to the preprocessed low-precision heat transfer data based on a Gaussian regression equation;
determining a high-precision model according to the preprocessed high-precision heat transfer data based on the Gaussian regression equation;
determining a multi-precision model according to the low-precision heat transfer data, the low-precision model, the high-precision heat transfer data and the high-precision model by utilizing the Cokriging method based on the thermal equilibrium control model, the multi-precision model is a machine heat transfer model which takes dimensionless parameters of screened heat transfer data of the supercritical pressure fluid as an input and takes the convective heat transfer coefficient as an output, the screened heat transfer data of the supercritical pressure fluid include the on-way flow rate of the fluid, the wall surface temperature, the main flow temperature of the fluid, the fluid pressure, and the passage characteristic length, the machine heat transfer model is used for determining on-way thermal parameters about the working fluids flowing and transferring heat in the fluid passages.

The determining a multi-precision model according to the low-precision heat transfer data, the low-precision model, the high-precision heat transfer data and the high-precision model by utilizing the Cokriging method specifically includes: dividing the high-precision heat transfer data into a training set and a testing set; determining the multi-precision model according to a formula: \hat{f}₂(X)=ρ(X)\hat{f}₁(X)+δ(X), by utilizing the training set; where, \hat{f}₂(X) is a high-precision model; ρ(X) is a scale factor for quantifying a relationship between outputs of two precision models; \hat{f}₁(X) is a low-precision model; δ(X) is a Gaussian process.

In step 105, the on-way thermal parameters about the working fluid flowing and transferring heat in the fluid passages are determined according to the machine heat transfer model. The on-way thermal parameters include a fluid temperature, a fluid velocity and a pressure loss.

In step 106, the heat transfer area is determined according to the on-way thermal parameters.

In step 107, it is determined whether the heat transfer area meets a target heat transfer area, if yes, step 108 is performed, and if not, step 109 is performed.

In step 108, the heat exchanger for supercritical pressure fluid is manufactured according to the preliminary framework of the heat exchanger.

In step 109, the primary framework of the heat exchanger is readjusted until the heat transfer area meets the target heat transfer area.

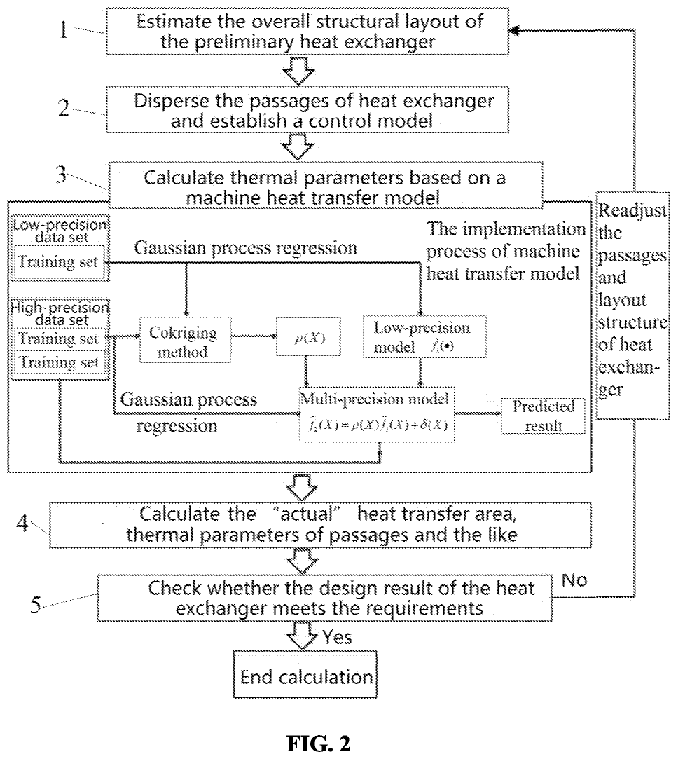

In practical application, FIG. 2 is a flowchart of a design method of the heat exchanger for supercritical pressure fluid in combination with machine learning provided by the present disclosure. As shown in FIG. 2, the design method includes:

1) Primarily Designing an Overall Structure of the Heat Exchanger.

The known boundary conditions for the design of the heat exchanger mainly include the inlet temperature, the pressure and the flow of the first working fluid and the inlet temperature, the outlet temperature, the pressure and the flow of the second working fluid. Firstly, the outlet temperature of the first working fluid is calculated according to given boundary conditions and a thermal equilibrium equation. Secondly, a logarithmic mean temperature difference is calculated by a following expression according to the inlet and outlet temperatures of the first working fluid and the second working fluid,

$$Δ {t}_{m} = \frac{Δ {t}^{′} - Δ {t}^{″}}{ln \frac{Δ {t}^{′}}{Δ {t}^{″}}} \qquad ( 1 )$$

where, Δt′ is a difference value between an inlet temperature of a working fluid at a hot side and an outlet temperature of a working fluid at a cold side, Δt″ is a difference value between an outlet temperature of the working fluid at the hot side and inlet temperature of the working fluid at the cold side.

Via the inlet and outlet temperatures and pressure information of the working fluids at the two sides of the heat exchanger, physical property parameters of the working fluids at qualitative temperature, such as density ρ, dynamic viscosity μ, thermal conductivity λ, are determined, and criterion numbers such as an average Reynolds number Re_{b} of the main flow and a Prandtl Number Pr are calculated. The average Nusselt number Nu₀ is calculated by the following criteria correlation equation:

$${Nu}_{0} = \frac{( ξ / 8 ) {Re}_{b} \overline{Pr}}{12.7 \sqrt{ξ / 8} ( \overline{{Pr}^{2 / 3}} - 1 ) + 1.07} , \\ ξ = \frac{1}{{( 1.82 {log}_{10} {Re}_{b} - 1.64 )}^{2}} \qquad ( 2 )$$

wherein, P̅r̅ is the average Prandtl Number, ξ is a friction factor.

After the average Nusselt number is obtained, the average convective heat transfer coefficients of working fluids in the passages at two sides of the heat transfer unit are calculated:

$${h}_{h} = \frac{{Nu}_{0 h} {λ}_{h}}{d} , {h}_{c} = \frac{{Nu}_{0 c} {λ}_{c}}{d} \qquad ( 3 )$$

where, subscripts h and c respectively represent the fluids at hot and cold sides, and d is the equivalent diameter of flow passage. After the convective heat transfer coefficients of the two sides are calculated, a total heat transfer coefficient k can be obtained by the following expression:

$$k = \frac{1}{\frac{1}{{h}_{h}} + \frac{δ}{λ} + \frac{1}{{h}_{c}}} \qquad ( 4 )$$

where λ is a thermal conductivity of a metal plate between the cold and hot flow passages, and δ is an average thickness of the plate. The heat flux may be obtained by the total heat transfer coefficient and the logarithmic mean temperature difference:

q=kΔtₘ (5)

The total heat transfer area A is calculated according to the heat transfer amount q and the heat flux, and a per unit flow passage length L is calculated according to the number of the flow passages N and a per unit heat transfer surface area of flow passage:

$$A = \frac{Φ}{q} \qquad ( 6 )$$

$$l = \frac{A}{2 N ( π + 2 ) R} \qquad ( 7 )$$

The overall framework of the heat exchanger is preliminarily obtained through the above calculations, and includes the equivalent diameter, the passage length and the passage number, the arrangements of the cold fluid passages and the hot fluid passages and the like of the heat exchanger. It is possible to carry out calculation on the thermal parameters of the local flowing working fluid along passages of the heat exchanger according to the established preliminary framework of the heat exchanger;

2) Dispersing the Passages of Heat Exchanger and Establishing a Control Model.

According to the preliminary framework of the heat exchanger obtained in the process 1), each flow passage unit is divided along the fluid flow direction into n micro sections in a equal or unequal manner, and a system of thermal equilibrium equations is established for each micro section.

qᵢ=q_{m_hi}c_{p_hi}(tₕᵢ−tₕᵢ₊₁) (9)

qᵢ=q_{m_ci}c_{p_ci}(t_{ci}−t_{ci+1}) (10)

qᵢ=kᵢAᵢ(t_{m_hi}−t_{m_ci}) (11)

In the above formulas, qᵢ is a heat flux in the i-th micro section; q_{m_ci} and q_{m_hi} are respectively cold and hot fluid flows; c_{p_hi} and c_{p_ci} are respectively the specific heat capacities at constant pressure of the hot and cold fluid; t_{m_ci} and t_{m_hi} are respectively temperatures of the second working fluid and the first working fluid at the central nodes of the i-th micro section; Aᵢ is a heat transfer area in the i-th micro section, subscribe i represents the i-th micro section, and i+1 represents a next micro section relative to the i-th micro section.

3) Calculating the Thermal Parameters Based on the Machine Heat Transfer Model.

The implementation process mainly includes the following three aspects.

\textcircled{1} Collecting and Cleaning the Heat Transfer Data of the Existing Supercritical Pressure Fluid.

The experimental data and numerical simulation data are collected and summarized, which generally include the on-way flow rate of the fluid, the wall surface temperature, the temperature of the main flow of the fluid, the fluid pressure, the convective heat transfer coefficient and the passage characteristic length and the like. And a set of the data is cleaned, and abnormal data, outliers and the like contained in the data set are deleted.

The Nusselt number is a common dimensionless number in heat transfer theory, and represents an intensity of convective heat transfer in a physical sense, and the larger the value of the Nusselt number is, the stronger the intensity of convective heat transfer of fluid is, namely, the convective heat transfer performance is stronger. In general, it can be assumed that the Nusselt number is a function of a series of characteristic parameters and a vector including these characteristic parameters is x, then:

Nu=f(x).

The form of the feature vector x may vary depending on the parameters contained in the data set. In the present disclosure, the Reynolds number Re, Prandtl Number Pr, Bo* number, the ratio of physical properties calculated in the preprocessing step, and the dimensionless position corresponding to the parameter in the passage will be used as the characteristic parameters during prediction, that is,

$$x = ( \frac{x}{d} , Re , Pr , {Bo}^{*} , \frac{\overline{{c}_{p}}}{{c}_{pb}} , \frac{{ρ}_{b}}{{ρ}_{w}} ) .$$

The data set includes a high-precision data set and a low-precision data set, which include values of all the parameter in the feature vector and the value of the Nusselt number Nu to be predicted finally. The high and low precision mainly refers to the precision of a target value, i.e., Nusselt number Nu, to be predicted finally. The high-precision data set refers to a data set obtained by experiment data or numerical simulation data, and the low-precision data set refers to data predicted by using the dimensionless criterion correlation equation such as the formula (2) obtained based on existing research.

\textcircled{2} Constructing a Machine Learning Algorithm in Combination with the Gaussian Regression Process and the Cokriging Method, and Training a Multi-Precision Substitution Model by Using the Existing Data.

All data including the high-precision data set and the low-precision data set are randomly sampled, and then divided into a training set and a testing set which do not intersect with each other. The training set is used for training the machine learning model, and the testing set is used for evaluating the predictive performance of the machine learning model.

In the training process, the input parameters to the model are all parameters (i.e. the flow rate, the wall surface temperature, the temperature of the main flow of the fluid, the fluid pressure and the characteristic length) in the training set except for the convective heat transfer coefficient, and the output parameters are the convective heat transfer coefficient. The training is performed in an iterative manner. In each iteration, the output convective heat transfer coefficient is compared with the convective heat transfer coefficient in training set, and the iteration is performed continuously until a deviation therebetween is minimized, so as to obtain a substitution model for predicting the convective heat transfer coefficient of the supercritical fluid. There are two methods for training the substitution model, one of them uses the Gaussian regression process to construct a multi-precision substitution model and another uses the Cokriging method. The training process of these two substitution models is shown in FIG. 1. Specifically, in the training process by the gaussian regression process, the training set from the high-precision data set is directly adopted for training to obtain the substitute model. In the training process by the Cokriging method, the training data set from low-precision data set firstly is used for training to obtain a Gaussian process, namely a low-precision model \hat{f}₁; and then, the training data set from the high-precision data set is used for training to obtain a new Gaussian process δ, namely high-precision model. Next, the low-precision data, the low-precision model, the high-precision data and the high-precision model are used simultaneously for training a multi-precision model through a Cokriging method. Lastly, relevant parameters in a training result are stored.

\textcircled{3} Predicting and Calculating Process

Similar to the data preprocessing step, the on-way thermophysical property parameters of the system are transformed into a dimensionless form, so that the format and the physical meaning thereof are consistent with those of the input parameters in the training process.

The dimensionless parameters transformed are substituted into the multi-precision substitution model trained to calculate the local convective heat transfer coefficients of the passages of the heat exchanger.

4) Calculating a “Actual” Heat Transfer Area and Thermal Parameters of Passages Based on a Machine Heat Transfer Model.

The on-way thermal parameters about the working fluids flowing and transferring heat in the passages of the heat exchanger, which mainly includes a temperature, a velocity, a pressure loss and the like, is calculated by the machine heat transfer model established in the process 3), to obtain a heat transfer area “actually” required.

5) Checking the Design Result of the Heat Exchanger

It is checked whether the structure obtained in the process 4) meets requirements according to design target parameters and constraint conditions of the heat exchanger. If yes, the design of the heat exchanger is finished; if not, the passage structure of the heat exchanger in the process 1) is adjusted, and the operations of the process 2), the process 3) and the process 4) are repeated until the check result for design in the process 5) meets the design target requirements of the heat exchanger.

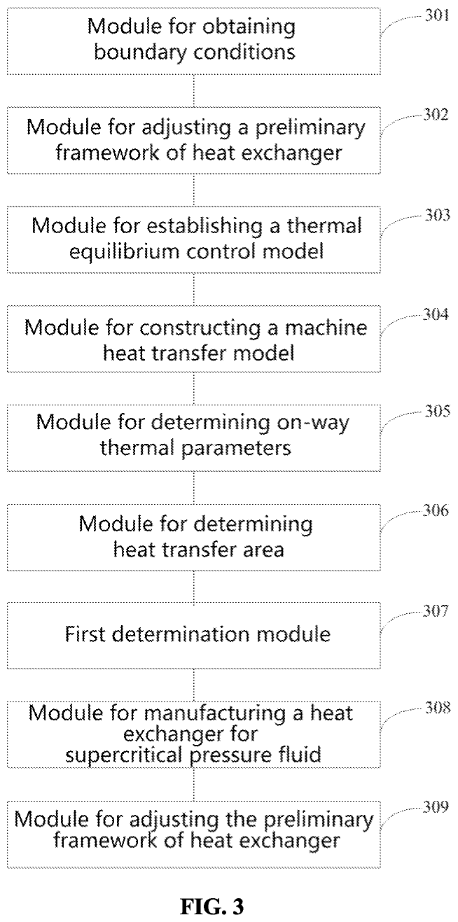

FIG. 3 is a structural chart of a system for manufacturing the heat exchanger for supercritical pressure fluid provided by the present disclosure. It is provided a system for manufacturing a heat exchanger for supercritical pressure fluid as shown in FIG. 3, and a first working fluid is arranged in hot fluid passages of the heat exchanger for supercritical pressure fluid, and a second working fluid is arranged in cold fluid passages of the heat exchanger for supercritical pressure fluid, the system includes a module for obtaining boundary conditions 301, a module for adjusting a preliminary frame of heat exchanger 302, a module for establishing a thermal equilibrium control model 303, a module for constructing a machine heat transfer model 304, a module for determining on-way thermal parameters 305, a module for determining heat transfer area 306, a first determination module 307, a module for manufacturing the heat exchanger for supercritical pressure fluid 308, and a module for adjusting the preliminary framework of the heat exchanger 309.

The module 301 is configured to obtain the boundary conditions of the heat exchanger for supercritical pressure fluid, which include first and second working fluid parameters. The first working fluid parameters include an inlet temperature, an outlet temperature, a pressure and a flow of the first working fluid. The second working fluid parameters include an inlet temperature, an outlet temperature, a pressure and a flow of the second working fluid.

The module 302 is configured to adjust a preliminary framework of the heat exchanger based on the boundary conditions. The preliminary framework of the heat exchanger includes a equivalent diameter, a length and a number of passages, and arrangements of cold fluid passages and hot fluid passages of the heat exchanger.

The module 302 specifically includes: a unit for determining an average Nusselt number, configured for determining the average Nusselt number according to the first and the second working fluid parameters; a unit for determining the equivalent diameter of passages, configured for determining a first average convective heat transfer coefficient of the first working fluid and a second average convective heat transfer coefficient of the second working fluid respectively and determining the equivalent diameter of passages according to the average Nusselt number; a unit for determining a total heat transfer coefficient, configured for determining the total heat transfer coefficient according to the first average convective heat transfer coefficient and the second average convective heat transfer coefficient; a unit for determining a heat exchange quantity, configured for determining the heat transfer quantity according to the total heat transfer coefficient; a unit for determining the length and the number of passages, configured for determining the passage length and the passage number according to the heat transfer quantity; a unit for determining the arrangements of cold fluid passages and hot fluid passages, configured for determining the arrangements of cold fluid passages and hot fluid passages according to the passage length and the passage number; and, a unit for determining the preliminary framework of the heat exchanger, configured for determining the preliminary framework of the heat exchanger according to the equivalent diameter, the passage length and the passage number, and the arrangements of cold fluid passages and hot fluid passages.

The module 303 is configured to divide each fluid passage along a fluid flow direction and establishing a thermal equilibrium control model for each divided fluid passage based on the preliminary framework of the heat exchanger. The fluid passages include hot fluid passages and cold fluid passages; one of the fluid passages includes a plurality of divided fluid passages.

The module 303 specifically includes a unit for establishing the thermal equilibrium control model, configured for establishing the thermal equilibrium control model. The thermal equilibrium control model is as follows:

qᵢ=q_{m_hi}c_{p_hi}(tₕᵢ−tₕᵢ₊₁)

qᵢ=q_{m_ci}c_{p_ci}(t_{ci}−t_{ci+1})

qᵢ=kᵢAᵢ(t_{m_hi}−t_{m_ci});

wherein qᵢ are a heat flux in a i-th divided fluid passage; q_{m_ci} is a flow of the cold fluid; q_{m_hi} is a flow of the hot fluid flow; c_{p_hi} is a specific heat capacity at constant pressure of the hot fluid; c_{p_ci} is a specific heat capacity at constant pressure of the cold fluid; t_{m_ci} is a temperature of the first working fluid at a central node of the i-th divided fluid passage; t_{m_hi} is a temperature of the second working fluid at the central node of the i-th divided fluid passage; Aᵢ is a heat transfer area in the i-th divided fluid passage; i represents the i-th divided fluid passage; and i+1 represents a next divided fluid passage relative to the i-th divided fluid passage.

The module 304 is configured to construct a machine heat transfer model in combination with a Gaussian regression process and a Cokriging method based on the thermal equilibrium control model.

The module 304 specifically includes a module for obtaining heat transfer data of the supercritical pressure fluid, a preprocessing module, a module for determining a low-precision model, a module for determining a high-precision model, a module for determining a multi-precision model.

The module for obtaining heat transfer data of the supercritical pressure fluid is configured for obtaining the heat transfer data of the supercritical pressure fluid. The heat transfer data of the supercritical pressure fluid include high-precision and low-precision heat transfer data. The high-precision heat transfer data are a data set obtained from experiment or numerical simulation data, and the low-precision heat transfer data are a data set predicted by a dimensionless criterion correlation equation. The heat transfer data of the supercritical pressure fluid are an on-way flow rate of the fluid, a wall surface temperature, a temperature of a main flow of the fluid, a fluid pressure, a convective heat transfer coefficient and the passage characteristic length.

The preprocessing module is configured for preprocessing the heat transfer data of the supercritical pressure fluid, and determining the preprocessed heat transfer data of supercritical pressure fluid. The preprocessed heat transfer data of the supercritical pressure fluid includes preprocessed low-precision and preprocessed high-precision heat transfer data.

The module for determining a low-precision model is configured for determining the low-precision model according to the preprocessed low-precision heat transfer data based on the Gaussian regression equation.

The module for determining a high-precision model is configured for determining a high-precision model according to the preprocessed high-precision heat transfer data based on the Gaussian regression equation.

The module for determining a multi-precision model is configured for determining the multi-precision model according to the low-precision heat transfer data, the low-precision model, the high-precision heat transfer data and the high-precision model by utilizing the Cokriging method based on the thermal equilibrium control model. The multi-precision model is a machine heat transfer model which takes dimensionless parameters of screened heat transfer data of the supercritical pressure fluid as an input and takes the convective heat transfer coefficient as an output. The screened heat transfer data of the supercritical pressure fluid include the on-way flow rate of the fluid, the wall surface temperature, the temperature of the main flow of the fluid, the fluid pressure, the convective heat transfer coefficient and the passage characteristic length. The machine heat transfer model is used for determining the on-way thermal parameters about the working fluids flowing and transferring heat in the fluid passages.

The module for determining the multi-precision model specifically includes: a dividing unit, configured for dividing the high-precision heat transfer data into a training set and a testing set; an unit for determining the multi-precision model, configured for determining the multi-precision model according to a formula \hat{f}₂(X)=ρ(X)\hat{f}₁(X)+δ(X) by utilizing the training set. where, \hat{f}₂(X) is the high-precision model; ρ(X) is a scale factor for characterizing a quantitative relationship between output values of two precision model; \hat{f}₁ (X) is the low-precision model; δ(X) is the Gaussian process.

The module 305 is configured for determining the on-way thermal parameters of about the working fluids flowing and transferring heat in the fluid passages according to the machine heat transfer model. The on-way thermal parameters include a fluid temperature, a fluid velocity and a pressure loss.

The module 306 is configured for determining the heat transfer area according to the on-way thermal parameters.

The first determination module 307 is configured for determining whether the heat transfer area meets a target heat transfer area to obtain a first determination result.

The module 308 is configured for manufacturing the heat exchanger for supercritical pressure fluid according to the preliminary framework of the heat exchanger if the first determination result indicates that the heat transfer area meets the target heat transfer area.

The module 309 is configured for readjusting the primary framework of the heat exchanger until the heat transfer area meets the target heat transfer area if the first determination result indicates that the heat transfer area fails to meet the target heat transfer area standard.

The machine heat transfer model established by the disclosure simultaneously employs high-precision data directly from numerical simulation for the supercritical pressure fluid, data calculated by utilizing criterion correlation equation of convection heat transfer and limited experimental data, and the prediction precision of the machine heat transfer model is higher, and particularly, the machine heat transfer model can provide more high-precision prediction for some extreme and unsteady heat transfer working conditions of the supercritical pressure fluid.

Meanwhile, the method for constructing the heat transfer machine model according to the disclosure can not only obtain the heat transfer coefficient of the supercritical pressure fluid with a higher precision than that of a heat transfer criterion correlation equation, but also itself has good generalization performance and stronger maneuverability. The model itself can be continuously improved in respect of the prediction precision by employing more and higher-precision data, and thus is healthily growing.

The disclosure trains a machine learning substitution model for heat transfer coefficient by means of the Gaussian process regression and Cokriging method in the machine learning technology and in combination with high-precision data from experiments and low-precision data predicted by the correlation equation. The substitution model is applied in the calculation process of the discrete iterative design about a heat exchanger as a substitution of the traditional method of designing the heat exchanger by using the empirical correlation equation, to quickly and accurately predict the on-way thermal parameters of the working fluid in the passages of heat exchanger, and eventually obtain a design solution of heat exchanger with higher comprehensive performance in respect of flow heat transfer.

The embodiments in the present description are described in a progressive manner, each embodiment focuses on differences from other embodiments, and the same and similar parts among the various embodiments can be referred to each other. For the system disclosed by the embodiment, its description is relatively simple because it corresponds to the method disclosed in the embodiment, and the relevant parts can be referred to the description of the method.

The principle and the implementation of the present disclosure are explained by using specific examples in the present description, and the above description of the embodiments is only used to help understand the method and the core idea of the present disclosure; meanwhile, it is apparent for a person skilled in the art to modify the specific embodiments and the application range according to the idea of the present disclosure. In conclusion, the contents of the description should not be construed as limitations on the disclosure.

The functions of the various elements/modules shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It is to be understood that the present principles may be implemented in various forms of hardware, software, firmware, special purpose processors, or a combination thereof. Preferably, the present principles may be implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present principles is programmed. Given the teachings herein, one of ordinary skill in the related art will be able to contemplate these and similar implementations or configurations of the present principles.

What is claimed is:

1. A method for manufacturing a heat exchanger for supercritical pressure fluid, which has a first working fluid arranged in hot fluid passages of the heat exchanger, and a second working fluid arranged in cold fluid passages of the heat exchanger, the method comprising:
obtaining boundary conditions of the heat exchanger representing first working fluid parameters and second working fluid parameters, the first working fluid parameters having an inlet temperature, an outlet temperature, a pressure and a flow of the first working fluid, the second working fluid parameters having an inlet temperature, an outlet temperature, a pressure and a flow of the second working fluid;
adjusting a preliminary framework of the heat exchanger based on the obtained boundary conditions, the preliminary framework of the heat exchanger having a passage equivalent diameter, a passage length, a passage number, and arrangements of the cold fluid passages and the hot fluid passages of the heat exchanger;
dividing each of the fluid passages along a fluid flow direction and establishing a thermal equilibrium control model for each divided fluid passage based on the preliminary framework of the heat exchanger, the fluid passages including the hot fluid passages and the cold fluid passages; each of the fluid passages having a plurality of the divided fluid passages;
constructing a machine heat transfer model in combination with a Gaussian regression process and a Cokriging method based on the established thermal equilibrium control model;
determining on-way thermal parameters about the working fluids flowing and transferring heat in the fluid passages according to the machine heat transfer model, the on-way thermal parameters including a fluid temperature, a fluid velocity and a pressure loss;
determining a heat transfer area according to the on-way thermal parameters;
determining whether the heat transfer area meets a target heat transfer area, to obtain a first determination result:
manufacturing the heat exchanger according to the preliminary framework of the heat exchanger, when the determination of on-way thermal parameters result indicates that the pressure loss across heat transfer area is lower than design demand; and
readjusting the primary framework of the heat exchanger until the heat transfer area meets the limitation of pressure loss, when the determination of on-way thermal parameters result indicates that the heat transfer area fails to meet the a predetermined limitation of pressure loss.

2. The method for manufacturing a heat exchanger for supercritical pressure fluid according to claim 1, wherein the adjusting a preliminary framework of the heat exchanger based on the boundary conditions comprises:
determining an average Nusselt number according to the first working fluid parameters and the second working fluid parameters;
determining a first average convective heat transfer coefficient of the first working fluid and a second average convective heat transfer coefficient of the second working fluid, respectively, and determining the passage equivalent diameter according to the average Nusselt number;
determining a total heat transfer coefficient according to the first average convective heat transfer coefficient and the second average convective heat transfer coefficient;
determining a heat transfer quantity according to the total heat transfer coefficient;
determining the passage length and the passage number according to the heat transfer quantity;
determining the arrangements of cold fluid passages and hot fluid passages according to the passage length and the passage number; and
determining the preliminary framework of the heat exchanger according to the passage equivalent diameter, the passage length, the passage number, and the arrangements of cold fluid passages and hot fluid passages.

3. The method for manufacturing a heat exchanger for supercritical pressure fluid according to claim 1, wherein the dividing each of the fluid passages along a fluid flow direction and establishing a thermal equilibrium control model for each divided fluid passage based on the preliminary framework of the heat exchanger comprises:
the thermal equilibrium control model being as follows:
qᵢ=q_{m_hi}c_{p_hi}(tₕᵢ−tₕᵢ₊₁)
qᵢ=q_{m_ci}c_{p_ci}(t_{ci}−t_{ci+1})
qᵢ=kᵢAᵢ(t_{m_hi}−t_{m_ci});
where qᵢ is a heat flux in a i-th divided fluid passage; q_{m_ci} is a flow of a cold fluid; q_{m_hi} is a flow of a hot fluid; c_{p_hi} is a specific heat capacity at constant pressure of the hot fluid; c_{p_ci} is a specific heat capacity at constant pressure of the cold fluid; t_{m_ci} is a temperature of the first working fluid at a central node of the i-th divided fluid passage; t_{m_hi} is a temperature of the second working fluid at the central node of the i-th divided fluid passage; Aᵢ is a heat transfer area in the i-th divided fluid passage; i represents the i-th divided fluid passage, and i+1 represents a next divided fluid passage relative to the i-th divided fluid passage.

4. The method for manufacturing a heat exchanger for supercritical pressure fluid according to claim 1, wherein the constructing a machine heat transfer model in combination with a Gaussian regression process and a Cokriging method based on the thermal equilibrium control model comprises:
obtaining heat transfer data of the supercritical pressure fluid, the heat transfer data of the supercritical pressure fluid including high-precision heat transfer data and low-precision heat transfer data, the high-precision heat transfer data being a data set obtained from experimental or numerical simulation data, the low-precision heat transfer data being a data set predicted by a dimensionless criterion correlation equation, the heat transfer data of the supercritical pressure fluid being an on-way flow rate of the fluid, a wall surface temperature, a temperature of a main flow of the fluid, a fluid pressure, a convective heat transfer coefficient and a passage characteristic length;
preprocessing the heat transfer data of the supercritical pressure fluid and determining preprocessed heat transfer data of supercritical pressure fluid, the preprocessed heat transfer datum of the supercritical pressure fluid including preprocessed low-precision heat transfer data and preprocessed high-precision heat transfer data;
determining a low-precision model according to the preprocessed low-precision heat transfer data based on a Gaussian regression equation;
determining a high-precision model according to the preprocessed high-precision heat transfer data based on the Gaussian regression equation;
determining a multi-precision model according to the low-precision heat transfer data, the low-precision model, the high-precision heat transfer data and the high-precision model by utilizing the Cokriging method based on the thermal equilibrium control model, the multi-precision model being a machine heat transfer model which receives dimensionless parameters of screened heat transfer data of the supercritical pressure fluid as an input and the convective heat transfer coefficient as an output, the screened heat transfer data of the supercritical pressure fluid including the on-way flow rate of the fluid, the wall surface temperature, the temperature of the main flow of the fluid, the fluid pressure, the convective heat transfer coefficient and the passage characteristic length, the machine heat transfer model being used for determining on-way thermal parameters about the working fluid flowing and transferring heat in the fluid passages.

5. The method for manufacturing a heat exchanger for supercritical pressure fluid according to claim 4, wherein the determining a multi-precision model according to the low-precision heat transfer data, the low-precision model, the high-precision heat transfer data and the high-precision model by utilizing the Cokriging method comprises:
dividing the high-precision heat transfer data into a training set and a testing set;
determining the multi-precision model according to a formula: \hat{f}₂(X)=ρ(X)\hat{f}₁(X)+δ(X) by utilizing the training set, where \hat{f}₂(X) is a high-precision model; \hat{f}₁(X) is a low-precision model; ρ(X) is a scale factor for quantifying a relationship between outputs of the high-precision model and the low-precision model; δ(X) is a Gaussian process.

6. A system for manufacturing a heat exchanger for supercritical pressure fluid, which has a first working fluid arranged in hot fluid passages of the heat exchanger and a second working fluid arranged in cold fluid passages of the heat exchanger, the system comprising:
a module for obtaining boundary conditions, configured for obtaining the boundary conditions of the heat exchanger, the boundary conditions including first working fluid parameters and second working fluid parameters, the first working fluid parameters including an inlet temperature, an outlet temperature, a pressure and a flow of the first working fluid, the second working fluid parameters including an inlet temperature, an outlet temperature, a pressure and a flow of the second working fluid;
a module for adjusting a preliminary framework of the heat exchanger, configured for adjusting the preliminary framework of the heat exchanger based on the obtained boundary conditions, the preliminary framework of the heat exchanger having a passage equivalent diameter, a passage length, a passage number, and arrangements of cold fluid passages and hot fluid passages of the heat exchanger;
a module for establishing a thermal equilibrium control model, configured for dividing each of fluid passages along a fluid flow direction and establishing a thermal equilibrium control model for each divided fluid passage based on the preliminary framework of the heat exchanger, the fluid passages including hot fluid passages and cold fluid passages, each of the fluid passages having a plurality of the divided fluid passages;
a module for constructing a machine heat transfer model, configured for constructing the machine heat transfer model in combination with a Gaussian regression process and a Cokriging method based on the thermal equilibrium control model;
a module for determining on-way thermal parameters, configured for determining the on-way thermal parameters about the working fluids flowing and transferring heat in the fluid passages according to the machine heat transfer model, the on-way thermal parameters including a fluid temperature, a fluid velocity and a pressure loss;
a module for determining a heat transfer area, configured for determining the heat transfer area according to the on-way thermal parameters;
a first determination module, configured for determining whether the heat transfer area meets a target heat transfer area to obtain a first determination result;
a module for manufacturing the heat exchanger, configured for manufacturing the heat exchanger according to the preliminary framework of the heat exchanger, when the first determination result indicates that the heat transfer area meets the target heat transfer area; and
a module for adjusting the preliminary framework of the heat exchanger, configured for readjusting the primary framework of the heat exchanger until the heat transfer area meets the target heat transfer area, when the first determination result indicates that the heat transfer area fails to meet the target heat transfer area.

7. The system for manufacturing a heat exchanger for supercritical pressure fluid according to claim 6, wherein the module for adjusting the preliminary framework of the heat exchanger comprises:
a unit for determining an average Nusselt number, configured for determining an average Nusselt number according to the first working fluid parameters and the second working fluid parameters;
a unit for determining the passage equivalent diameter, configured for determining a first average convective heat transfer coefficient of the first working fluid and a second average convective heat transfer coefficient of the second working fluid respectively and determining the passage equivalent diameter according to the average Nusselt number;
a unit for determining a total heat transfer coefficient, configured for determining the total heat transfer coefficient according to the first average convective heat transfer coefficient and the second average convective heat transfer coefficient;
a unit for determining a heat transfer quantity, configured for determining the heat transfer quantity according to the total heat transfer coefficient;
a unit for determining the passage length and the passage number, configured for determining the passage length and the passage number according to the heat transfer quantity;
a unit for determining the arrangements of cold fluid passages and hot fluid passages, configured for determining the arrangements of cold fluid passages and hot fluid passages according to the passage length and the passage number; and
a unit for determining the preliminary framework of the heat exchanger, configured for determining the preliminary framework of the heat exchanger according to the passage equivalent diameter, the passage length, the passage number, and the arrangements of cold fluid passages and hot fluid passages.

8. The system for manufacturing a heat exchanger for supercritical pressure fluid according to claim 6, wherein the module for establishing the thermal equilibrium control model comprises:
a unit for establishing a thermal equilibrium control model, configured for establishing a thermal equilibrium control model, and the thermal equilibrium control model being as follows:
qᵢ=q_{m_hi}c_{p_hi}(tₕᵢ−tₕᵢ₊₁)
qᵢ=q_{m_ci}c_{p_ci}(t_{ci}−t_{ci+1})
qᵢ=kᵢAᵢ(t_{m_hi}−t_{m_ci});
where qᵢ is a heat flux in a i-th divided fluid passages; q_{m_ci} is a flow of a cold fluid; q_{m_hi} is a flow of a hot fluid; c_{p_hi} is a specific heat capacity at constant pressure of the hot fluid; c_{p_ci} is a specific heat capacity at constant pressure of the cold fluid; t_{m_ci} is a temperature of the first working fluid at a central node of the i-th divided fluid passages; t_{m_hi} is a temperature of the second working fluid at the central node of the i-th divided fluid passages; Aᵢ is a heat transfer area in the i-th divided fluid passage; i represents the i-th divided fluid passages; and i+1 represents a next divided fluid passage relative to the i-th divided fluid passage.

9. The system for manufacturing a heat exchanger for supercritical pressure fluid according to claim 6, wherein the module for constructing the machine heat transfer model comprises:
a module for obtaining heat transfer data of the supercritical pressure fluid, configured for obtaining the heat transfer data of the supercritical pressure fluid, the heat transfer data of the supercritical pressure fluid comprising high-precision heat transfer data and low-precision heat transfer data, the high-precision heat transfer data being a data set obtained from experimental or numerical simulation data, the low-precision heat transfer data being a data set predicted by a dimensionless criterion correlation equation, the heat transfer data of the supercritical pressure fluid being an on-way flow rate of the fluid, a wall surface temperature, a temperature of a main flow of the fluid, a fluid pressure, a convective heat transfer coefficient and a passage characteristic length;
a preprocessing module, configured for preprocessing the heat transfer data of the supercritical pressure fluid and determining preprocessed heat transfer data of the supercritical pressure fluid, the preprocessed heat transfer datum of the supercritical pressure fluid including preprocessed low-precision heat transfer data and preprocessed high-precision heat transfer data;
a module for determining a low-precision model, configured for determining the low-precision model according to the preprocessed low-precision heat transfer data based on a Gaussian regression equation;
a module for determining a high-precision model, configured for determining a high-precision model according to the preprocessed high-precision heat transfer data based on the Gaussian regression equation;
a module for determining a multi-precision model, configured for determining the multi-precision model according to the low-precision heat transfer data, the low-precision model, the high-precision heat transfer data and the high-precision model by utilizing a Cokriging method based on the thermal equilibrium control model, the multi-precision model being a machine heat transfer model which takes dimensionless parameters of screened heat transfer data of the supercritical pressure fluid as an input and takes the convective heat transfer coefficient as an output, the screened heat transfer data of the supercritical pressure fluid including the on-way flow rate of the fluid, the wall surface temperature, the temperature of the main flow of the fluid, the fluid pressure, and the passage characteristic length, the machine heat transfer model being used for determining the on-way thermal parameters about the working fluid flowing and transferring heat in the fluid passages.

10. The system for manufacturing a heat exchanger for supercritical pressure fluid according to claim 9, wherein the module for determining the multi-precision model comprises:
a dividing unit, configured for dividing the high-precision heat transfer data into a training set and a testing set;
a unit for determining a multi-precision model, configured for determining a multi-precision model according to a formula: \hat{f}₂(X)=ρ(X)\hat{f}₁(X)+δ(X) by utilizing the training set, wherein \hat{f}₂(X) is a high-precision model; \hat{f}₁(X) is a low-precision model; ρ(X) is a scale factor for quantifying a relationship between outputs of the high-precision model and the low-precision model; δ(X) is a Gaussian process.
